(19) United States
(12) Patent Application Publication
(10) Pub. No.: US 2009/0153830 A1
(43) Pub. Date: Jun. 18, 2009

(54) Device for Transmission Image Detection for Use in a Lithographic Projection Apparatus and a Method for Determining Third Order Distortions of a Patterning Device and/or a Projection System of Such a Lithographic Apparatus

(75) Inventor: Haico Victor KOK, Veldhoven (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 12/334,658

(22) Filed: Dec. 15, 2008

Related U.S. Application Data
(60) Provisional application No. 60/996,993, filed on Dec. 13, 2007.

(51) Int. Cl. G03B 27/80

(52) U.S. Cl. 355/68

(57) ABSTRACT

Embodiments of the invention relate to a device for transmission image detection for use in a lithographic projection apparatus. In an embodiment, the device includes an array of gratings and an array of radiation sensitive sensors, each of which is arranged to receive radiation coming through one of the gratings. The array of radiation sensitive sensors may be a 1-dimensional diode array.

### CROSS-REFERENCE TO RELATED APPLICATIONS

The present application claims the benefit of U.S. Provisional patent Appl. No. 60/996,993, filed Dec. 13, 2007, which is incorporated herein by reference in its entirety.

### BACKGROUND

1. Field

Embodiments of the present invention relate to a device for transmission image detection for use in a lithographic projection apparatus.

2. Background

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In present lithographic projection apparatus, a device for transmission image detection is used in order to align a reticle to a wafer stage. It consists of a structure (e.g. grating) on a reticle and a complementary structure on a Transmission image detector plate. The aerial image of the structure is scanned using the Transmission image detector to determine position and focus of the image. The Transmission image detector has a small number (4-8) of such structures. Beneath each structure a photodiode is located to detect the light. With the current Transmission image detector, only two X-positions and two Y-positions can be measured simultaneously in the image field (one left in the image field and one right in the image field). With only four measurement positions in the image field the Transmission image detector can only measure position, magnification and rotation of the reticle with respect to the wafer stage. Higher order distortions, such as D3 (third order distortion) remain undetected. Such distortions arise as a consequence of reticle heating and/or lens heating.

### SUMMARY

It is desirable to detect third order distortions and field curvature of a lithographic projection apparatus using a Transmission image detector.

According to an embodiment of the invention, there is provided a device for transmission image detection including an array of gratings and an array of radiation sensitive sensors each of which is arranged to receive radiation coming through one of the gratings.

In a further embodiment, the invention relates to a lithographic apparatus including an illumination system configured to condition a radiation beam; a patterning device being capable of imparting the radiation beam with a pattern in its cross-section to form a patterned radiation beam, the patterning device including an array of first gratings; a substrate table constructed to hold a substrate; a projection system configured to project the patterned radiation beam onto a target portion of the substrate; a device for transmission image detection arranged on the substrate table, the device for transmission image detection including an array of second gratings and an array of radiation sensitive sensors, each of which is arranged to receive radiation coming through one of the first gratings and through one of the second gratings; and a processing device arranged to calculate third order distortions of at least one of the patterning device and the projection system using signals received from the radiation sensitive sensors.

Embodiments of the invention also relate to a method for determining third order distortions of at least one of a patterning device and a projection system of a lithographic apparatus, the method including creating a radiation beam; imparting the radiation beam with a pattern in its cross-section to form a patterned radiation beam using a patterning device, the patterning device including an array of gratings; providing a device for transmission detection on the substrate, the device for transmission detection including an array of gratings and an array of radiation sensitive sensors arranged to receive radiation coming through the gratings and to produce measurement signals; sensing radiation coming through the gratings of the patterning device and through the gratings of the device for transmission detection; and determining third order distortions of at least one of the patterning device and the projection system, using the measurement signals.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a lithographic apparatus according to the state of the art.

FIG. 2 depicts schematically a Transmission image detector according to the state of the art.

FIG. 3 shows an example of a Transmission image detector according to the state of the art.

FIG. 4 shows a Transmission image detector according to an embodiment of the invention.

FIG. 5 is an example of a reticle that may be used with the Transmission image detector of FIG. 4, according to an embodiment of the invention.

FIG. 6 shows an example of an array of gratings in which X-gratings alternate with Y-gratings, according to an embodiment of the invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

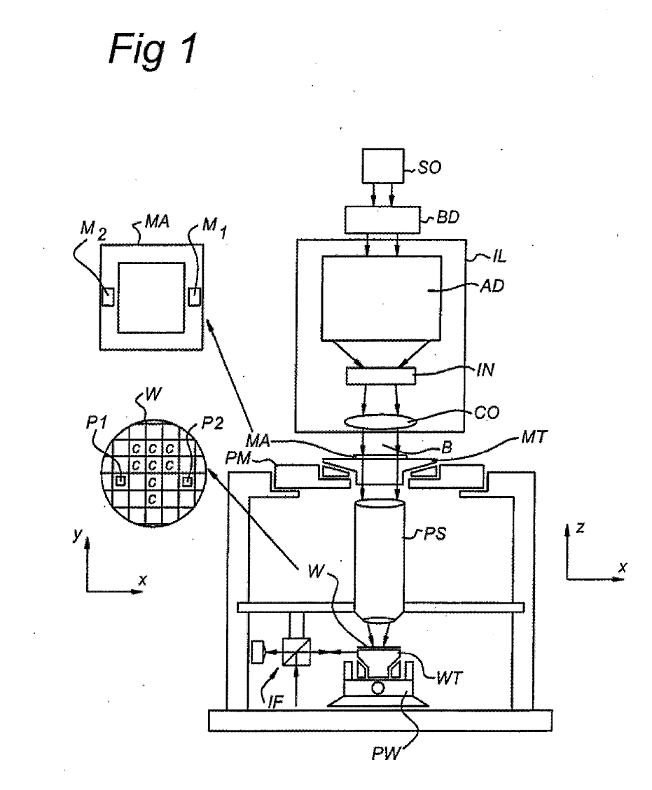

FIG. 1 schematically depicts a lithographic apparatus according to the state of the art. The apparatus includes:
an illumination system (illuminator) IL configured to condition a radiation beam B (e.g. UV radiation or DUV radiation).
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and
a projection system (e.g. a refractive projection lens system) PS configured to project a pattern imparted to radiation beam B by patterning device MA onto a target portion C (e.g. including one or more dies) of substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from source SO to illuminator IL with the aid of a beam delivery system BD including, for example, suitable directing mirrors and/or a beam expander. In other cases the source may be an integral part of the lithographic apparatus, for example when the source is a mercury lamp. Source SO and illuminator IL, together with beam delivery system BD if required, may be referred to as a radiation system.

Illuminator IL may include an adjuster AD for adjusting the angular intensity distribution of the radiation beam. Generally, at least the outer and/or inner radial extent (commonly referred to as 6-outer and 6-inner, respectively) of the intensity distribution in a pupil plane of the illuminator can be adjusted. In addition, illuminator IL may include various other components, such as an integrator IN and a condenser CO. The illuminator may be used to condition the radiation beam, to have a desired uniformity and intensity distribution in its cross-section.

Radiation beam B is incident on the patterning device (e.g., mask MA), which is held on the support structure (e.g., mask table MT), and is patterned by the patterning device. Having traversed mask MA, radiation beam B passes through projection system PS, which focuses the beam onto a target portion C of substrate W. With the aid of second positioner PW and position sensor IF (e.g. an interferometric device, linear encoder or capacitive sensor), substrate table WT can be moved accurately, e.g. so as to position different target portions C in the path of radiation beam B. Similarly, first positioner PM and another position sensor (which is not explicitly depicted in FIG. 1) can be used to accurately position mask MA with respect to the path of radiation beam B, e.g. after mechanical retrieval from a mask library, or during a scan. In general, movement of mask table MT may be realized with the aid of a long-stroke module (coarse positioning) and a short-stroke module (fine positioning), which form part of first positioner PM. Similarly, movement of substrate table WT may be realized using a long-stroke module and a short-stroke module, which form part of second positioner PW. In the case of a stepper (as opposed to a scanner), mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on mask MA, the mask alignment marks may be located between the dies.

The depicted apparatus could be used in at least one of the following modes:

1. In step mode, mask table MT and substrate table WT are kept essentially stationary, while an entire pattern imparted to the radiation beam is projected onto a target portion C at one time (i.e. a single static exposure). Substrate table WT is then shifted in the X and/or Y direction so that a different target portion C can be exposed. In step mode, the maximum size of the exposure field limits the size of the target portion C imaged in a single static exposure.

2. In scan mode, mask table MT and substrate table WT are scanned synchronously while a pattern imparted to the radiation beam is projected onto a target portion C (i.e. a single dynamic exposure). The velocity and direction of substrate table WT relative to mask table MT may be determined by the (de-)magnification and image reversal characteristics of projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, mask table MT is kept essentially stationary holding a programmable patterning device, and substrate table WT is moved or scanned while a pattern imparted to the radiation beam is projected onto a target portion C. In this mode, generally a pulsed radiation source is employed and the programmable patterning device is updated as required after each movement of substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

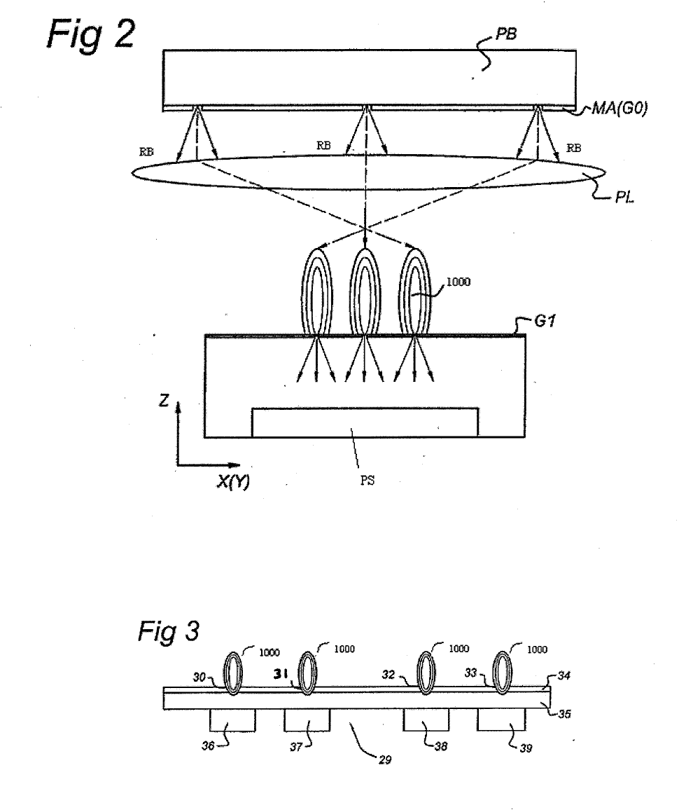

FIG. 2 depicts schematically a device for transmission image detection, also referred to as a Transmission image detector. Projection beam PB is incident on a first object G0, for example a grating in mask MA. First object G0 includes a plurality of openings arranged for creating an image from projection beam PB. The openings in first object G0 each emit a radiation beam RB originating from projection beam PB. The radiation beams emitted by the plurality of openings in first object G0 pass through a lens, for example, projection lens system PL. The optical properties of such a projection lens system are such that an aerial image 1000 of first object G0 is formed at a given plane below projection lens system PL. The Transmission image detector is positioned below projection lens system PL. The Transmission image detector includes a slot pattern G1 and a photo sensor device PS. Slot pattern G1 is an opening over photo sensor device PS which has the shape of a slit or a square. Advantageously, applying a pattern on the opening over photo sensor device PS increases the number of edges, which may increase the signal level and thus the signal/noise ratio of photo sensor PS.

The Transmission image detector is arranged on substrate table WT, see FIG. 1, for transfer relative to the position of projection lens system PL and mask MA in three orthogonal directions X, Y, and Z. By scanning along these three directions, the intensity of the aerial image can be mapped as a function of the XYZ position of the Transmission image detector, for example in an image map (a 3D map), which includes the coordinates of sampling locations and the intensity sampled at each location. From the 3D map, computational means connected to the Transmission image detector can derive the position of the aerial image by, for example, a parabolic fit of the top position using a least squares fitting method.

FIG. 3 shows an example of a Transmission image detector 29 according to the state of the art, with 4 gratings 30, 31, 32, 33 in a litho layer 34. Litho layer 34 is manufactured on a quartz window 35. Beneath each of gratings 30, 31, 32, 33, an associated photodiode 36, 37, 38, 39 is provided. With only 4 measurement positions in the image field, Transmission image detector 29 can only measure position, magnification, rotation, focus and focus tilt of the reticle with respect to the wafer stage. Higher order distortions, such as D3 (third order distortion) remain undetected. Such distortions arise as a consequence of reticle heating and/or lens heating.

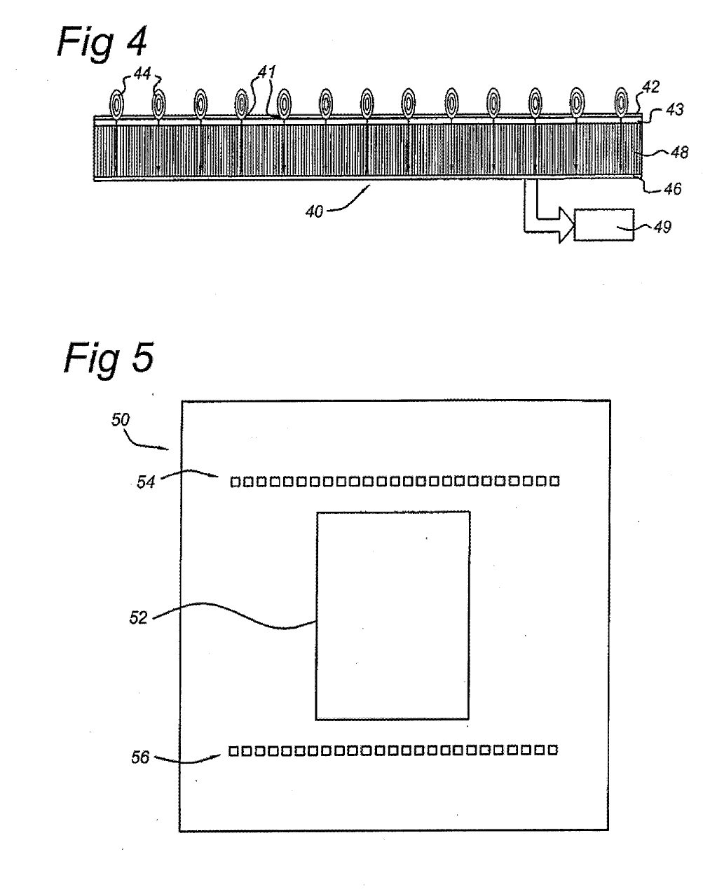

FIG. 4 shows a Transmission image detector 40 according to an embodiment of the invention. In this embodiment, Transmission image detector 40 includes an array of gratings 41 arranged on a litho layer 42. In FIG. 4, each grating is positioned so as to receive an aerial image 44 produced by an associated grating on a patterning device (e.g., a reticle) placed on mask table MT of the lithographic apparatus, see FIG. 1. Transmission image detector 40 further includes an array of radiation sensitive sensors 46 arranged to receive radiation coming through one of the gratings and to produce a measurement signal. Litho layer 42 may, for example, be a chrome layer patterned with a plurality of gratings arranged in a row. Litho layer 42 contains gratings 41 (x and y gratings). In an embodiment, it is possible to realize about 100 gratings in this Transmission image detector (compared to 4 effective a state-of-the-art Transmission image detector). The measurement signals are input to a processing device 49, which is arranged to determine third order distortions of the projection system (e.g. the lens) and/or of the patterning device. These third order distortions can be used to adjust the components of the lithographic apparatus, but they can also be used to improve alignment of the substrate table relative to the patterning device.

The Transmission image detector of FIG. 4 further includes a thin luminescent glass layer 43 that serves as a substrate for litho layer 42 and converts deep ultraviolet (DUV) photons into visible light. A second function is to convert DUV light that enters with an NA>1 into light that is emitted in all directions (including in the direction of radiation sensitive sensors 46). In an embodiment, instead of a luminescent glass layer, any other type of quantum conversion layer may be used. In this way each laser pulse of illumination system IL can be detected individually by Transmission image detector 40.

In an embodiment, array of radiation sensitive sensors 46 is a 1-dimensional diode array. This diode array may be integrated on a substrate with photo diodes arranged in a row. In another embodiment, array of radiation sensitive sensors 46 is a 1-dimensional CMOS camera. In yet another embodiment, array of radiation sensitive sensors 46 is a 1-dimensional CCD camera. Transmission image detector 40 may use a 1-dimensional camera with many pixels to do the sensing. A large number of gratings can be imaged simultaneously on such a camera.

In the embodiment of FIG. 4, Transmission image detector 40 includes a fiber optics block 48 in between gratings 41 and the respective radiation sensitive sensors 46.

The thick (e.g. 5 mm) fiber optics block 48 serves as a stable substrate for the luminescent glass and transports the image formed in the luminescent glass to the camera. The fiber optics block can be as thick as fits in the mirror block, and provides the needed stiffness of the detector.

In an embodiment, array of radiation sensitive sensors 46 is a high speed camera having a registration frequency of above 200 frames/second. If array of radiation sensitive sensors 46 is a 1-D camera, it has only a limited number of pixels and such a high speed will not cause any data processing problems. One camera image may be taken for each laser pulse.

It should be noted that instead of the use of light sensitive sensors and a quantum conversion layer, it is possible to use a Transmission image detector having an array of sensors that are sensitive to DUV radiation. In that configuration the sensors will be positioned directly under glass layer 43.

An example of a patterning device that may be used in conjunction with the Transmission image detector as described above is shown in FIG. 5. Reticle 50 has an array of gratings just above and below an image field 52, see grating array 54 and grating array 56. As can be seen from FIG. 5, the gratings are equally distributed over a significant range of reticle 50.

It should be appreciated by the skilled person that other configurations are possible and that an equal distribution of the gratings is not a necessity. Reticle 50 at the position of image field 52 may heat up due to absorption of radiation. The area outside image field 52 will remain relatively cool. This may cause distortion and bending of reticle 50. This distortion and bending cannot be measured with only two measurement positions in the field. The Transmission image detector according to an embodiment of the invention can measure the distortion and bending of reticle 50 with high accuracy due to the larger number of measurement points.

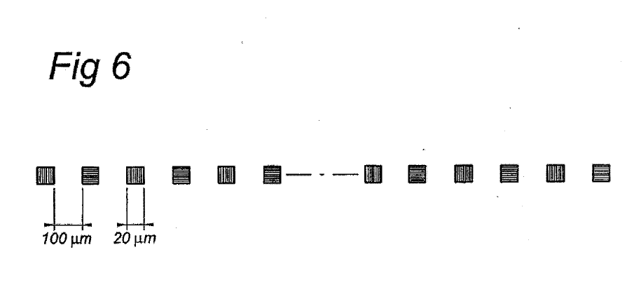

FIG. 6 shows an example of an array of gratings in which X-gratings alternate with Y-gratings, according to an embodiment of the invention. The spacing and size of the gratings could for example be as shown in FIG. 6, i.e. a pitch equal to 100 μm and a width of 20 μm. However, one of skill in the art will recognize that the invention is not so limited to the dimensions provided herein.

The proposed Transmission image detector has several advantages over the existing Transmission image detectors. The proposed Transmission image detector has many (e.g., more than 100) gratings. Each grating gives a measurement result. Thus many results can be averaged, and this will improve the reproducibility of a reticle alignment. Furthermore, higher order distortions of the reticle or lens can be measured in detail. This will improve overlay.

Finally, one can select the gratings to be used to match the image field of a user. This will also improve overlay.

Instead of positioning arrays of gratings next to image field 52, see FIG. 5, it is also possible to position gratings in scribe lanes between the dies. This will give even more accurate measurement of the location of the image field, and thus leads to an improved overlay.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the Transmission image detector may have a 2-dimensional camera, which will record radiation from a 2-dimensional array of gratings.

The descriptions above are intended to be illustrative, not limiting. Thus, it will be apparent to one skilled in the art that modifications may be made to the invention as described without departing from the scope of the claims set out below. It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A device for transmission image detection for use in a lithographic projection apparatus, said device comprising an array of gratings and an array of radiation sensitive sensors, each of which is arranged to receive radiation coming through one of said gratings.

2. The device for transmission image detection according to claim 1, wherein said array of radiation sensitive sensors is a 1-dimensional diode array.

3. The device for transmission image detection according to claim 1, wherein said array of radiation sensitive sensors is a 1-dimensional CMOS camera.

4. The device for transmission image detection according to claim 1, wherein said array of radiation sensitive sensors is a 1-dimensional CCD camera.

5. The device for transmission image detection according to claim 1, wherein said array of radiation sensitive sensors is a camera arranged to record images with a frequency of above 200 Hz.

6. The device for transmission image detection according to claim 1, wherein said device for transmission image detection comprises a quantum conversion layer on top of which said gratings are arranged.

7. The device for transmission image detection according to claim 6, wherein said device for transmission image detection comprises a fiber optics block in between said quantum conversion layer and said respective radiation sensitive sensors.

8. The device for transmission image detection according to claim 1, wherein said device comprises an array of more than 100 gratings and an array of more than 100 radiation sensitive

9. A lithographic apparatus comprising:
an illumination system configured to condition a radiation beam;
a patterning device being capable of imparting the radiation beam with a pattern in its cross-section to form a patterned radiation beam, said patterning device comprising an array of first gratings;
a substrate table constructed to hold a substrate;
a projection system configured to project the patterned radiation beam onto a target portion of the substrate,
a device for transmission image detection arranged on said substrate table, said device for transmission image detection comprising an array of second gratings and an array of radiation sensitive sensors each of which is arranged to receive radiation coming through one of said first gratings and through one of said second gratings; and
a processing device arranged to calculate third order distortions of at least one of said patterning device and said projection system using signals received from said radiation sensitive sensors.

10. A method for determining third order distortions of at least one of a patterning device and a projection system of a lithographic apparatus, said method comprising:
creating a radiation beam;
imparting the radiation beam with a pattern in its cross-section to form a patterned radiation beam using a patterning device, said patterning device comprising an array of gratings;
providing a device for transmission detection on said substrate, said device for transmission detection comprising an array of gratings and an array of radiation sensitive sensors arranged to receive radiation coming through said gratings and to produce measurement signals;
sensing radiation coming through said gratings of said patterning device and through said gratings of said device for transmission detection; and
determining third order distortions of at least one of said patterning device and said projection system, using said measurement signals.
